(19) United States
(12) Patent Application Publication
(10) Pub. No.: US 2012/0100410 A1
(43) Pub. Date: Apr. 26, 2012

(54) FUEL CELL SEPARATOR

(75) Inventors: Haeng Jin Ko, Seoul (KR); Young Bum Kum, Seoul (KR); Sae Hoon Kim, Yongin (KR); Yoo Chang Yang, Gunpo (KR); Yoo Sun Ku, Hwaseong (KR); Yun Seok Kim, Yongin (KR)

(73) Assignee: HYUNDAI MOTOR COMPANY, Seoul (KR)

(21) Appl. No.: 13/032,037

(22) Filed: Feb. 22, 2011

(30) Foreign Application Priority Data
Oct. 25, 2010 (KR) 10-2010-0104291

(51) Int. Cl. H01M 2/18

(52) U.S. Cl. 429/143; 429/144

(57) ABSTRACT

The present invention provides a fuel cell separator, in which a vortex generating structure is formed on the surface of a channel of the separator to induce a vortex of fluid (i.e., hydrogen and air) flowing through the channel, thus facilitating the supply of reactant gases and the removal of water droplets from a gas diffusion layer (GDL).

### CROSS-REFERENCE TO RELATED APPLICATION

This application claims under 35 U.S.C. §119(a) the benefit of Korean Patent Application No. 10-2010-0104291 filed Oct. 25, 2010, the entire contents of which are incorporated herein by reference.

### BACKGROUND

(a) Technical Field

The present disclosure relates to a fuel cell separator. More particularly, it relates to a fuel cell separator, in which a vortex generating structure is formed on the surface of a channel of the separator to induce a vortex of fluid (i.e., hydrogen and air) flowing through the channel, thus facilitating the supply of reactant gases and the removal of water droplets from a gas diffusion layer (GDL).

(b) Background Art

Research and development of a hydrogen fuel cell vehicle as an environmentally-friendly vehicle have continued to progress, and a fuel cell system applied to the hydrogen fuel cell vehicle comprises a fuel cell stack for generating electricity by an electrochemical reaction between reactant gases, a fuel processing system (FPS) for supplying hydrogen as a fuel to the fuel cell stack, an air processing system (APS) for supplying oxygen containing air as an oxidant required for the electrochemical reaction in the fuel cell stack, a thermal management system (TMS) for removing reaction heat from the fuel cell stack to the outside of the fuel cell system, controlling operation temperature of the fuel cell stack, and performing water management function, and a system controller for controlling the overall operation of the fuel cell system.

The configuration of a unit cell of the fuel cell stack will be described with reference to FIGS. 7 and 8 below.

A membrane-electrode assembly (MEA) is positioned in the center of each unit cell of the fuel cell stack. The MEA comprises a polymer electrolyte membrane 10, through which hydrogen ions (protons) are transported, and an electrode/catalyst layer, such as an air electrode 12 (“cathode”) and a fuel electrode 14 (“anode”), disposed on each of both sides of the polymer electrolyte membrane 10, in which an electrochemical reaction takes place.

A gas diffusion layer (GDL) 16 and a gasket 18 are sequentially stacked on the outside of the air electrode 12 and the fuel electrode 14. A separator 20 including flow fields for supplying fuel and discharging water produced by the reaction is stacked on the outside of the GDL 16. Further, an end plate 30 for supporting the above-described elements is connected to the outermost end.

An oxidation reaction of hydrogen occurs at the fuel electrode 14 of the fuel cell stack to produce hydrogen ions (protons) and electrons, and the produced hydrogen ions and electrons are transmitted to the air electrode 12 through the electrolyte membrane 10 and the separator 20, respectively. At the air electrode 12, the hydrogen ions and electrons transmitted from the fuel electrode 14 react with oxygen in air to produce water. Electrical energy generated by the flow of the electrons is supplied to a load requiring the electrical energy through a current collector (not shown) of the end plate 30.

As can be seen in FIG. 7, the separator 20 comprises a land 22 as a flat portion being in direct contact with the GDL 16 and a channel 24 as a space between the lands 22, through which hydrogen and air (oxygen) passes. The separator 20 functions to supply reactant gases such as hydrogen and air, remove water produced at the air electrode 12 from the GDL 16, and transmit electricity to an external circuit.

The types of the separators are divided into a graphite separator formed by a mechanical process and a metal separator formed by a stamping process. The channel 24 has a rectangular cross-section as shown in (a) of FIG. 7 or a trapezoidal cross-section as shown in (b) of FIG. 7. The surface of each channel 24 is smooth, and thus the actual flow of reactant gases has laminar flow characteristics.

However, the laminar flow is a flow where the flow velocity at the wall is smaller than that at the center of the channel, and thus a smooth film flow of water droplets cannot be ensured, which makes it difficult to remove the water trapped in pores of the GDL.

A separator in which the surface of a channel is coated with a hydrophilic material to form a film flow was proposed to solve the above-described problems. However, the coating layer may be worn out or separated by the flow of reactant gases during operation of the fuel cell stack for a long time, and thus the water removal efficiency of the separator is reduced by the reduction in the hydrophilicity of the coating layer. As a result, flooding occurs in each unit cell of the fuel cell stack, which reduces the amount of electricity generated and accelerates the deterioration of the electrodes, electrolyte membrane, etc.

Another separator was proposed, which comprises a projection in the form of a column for inducing a circular flow of reactant gases and performing a current collecting function, instead of the channel structure. However, it is difficult to precisely control the flow of reactant gases, and a non-uniform flow occurs according to the operating conditions of each unit cell of the fuel cell stack, which causes local damage of the electrodes and the electrolyte membrane. Moreover, it is difficult to remove the water trapped in pores of the GDL.

Still another a separator was proposed, which comprises a channel with a serpentine pattern, a straight line having at least one bent portion, or a wave pattern to improve the utilization of reactant gas and reduce the parasitic power. However, while it is easy to remove water, the amount of parasitic power is increased. Accordingly, the surface of the channel has a smooth plane or a plurality of projections of a submicron size.

The above-described prior art separators can remove the water droplets present in the channel through the wall of the channel or remove the water droplets in a two-phase flow, in which the water droplets are mixed with the reactant gases. However, the laminar flow is sustained in the actual flow of reactant gases in the channel, and thus it is difficult to remove small water droplets from open pores of the GDL.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with prior art. Accordingly, the present invention provides a fuel cell separator, in which a vortex generating means is integrally formed on the surface of a channel of the separator to create a vortex of reactant gases flowing through the channel, thus facilitating the removal of water droplets from a gas diffusion layer by the vortex of reactant gases.

In one aspect, the present invention provides a fuel cell separator comprising: lands being in contact with a gas diffusion layer; a channel formed between two of the lands and serving as a passage of reactant gases; and a vortex generating structure integrally formed on the surface of the channel for inducing a vortex of reactant gases.

The vortex generating structure may be formed on the entire or partial surface of the channel. Also, the vortex generating structure may be integrally formed by a stamping process on the surface of the channel or separately formed in advance.

Preferably, the inside of the channel may have a semicircular, elliptical, or trapezoidal cross-section. In this case, the vortex generating structure may comprise a plurality of spiral projections and grooves each having a semicircular or elliptical curved surface and repeatedly formed along the flow direction of the reactant gases. The number, radius, and length of the spiral projections and grooves of the vortex generating structure may suitably be adjusted to control the strength of the vortex of reactant gases generated.

The above and other aspects and preferred embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is diagram showing a fuel cell separator in accordance with an embodiment of the present invention.

FIG. 2 is a diagram showing a fuel cell separator in accordance with another embodiment of the present invention.

FIG. 3 is a diagram showing a fuel cell separator in accordance with still another embodiment of the present invention.

FIG. 4 is a diagram showing a fuel cell separator in accordance with the present invention.

FIG. 5 is a diagram showing the generation of a vortex of reactant gases and the removal of water droplets from a gas diffusion layer in the fuel cell separator in accordance with the present invention.

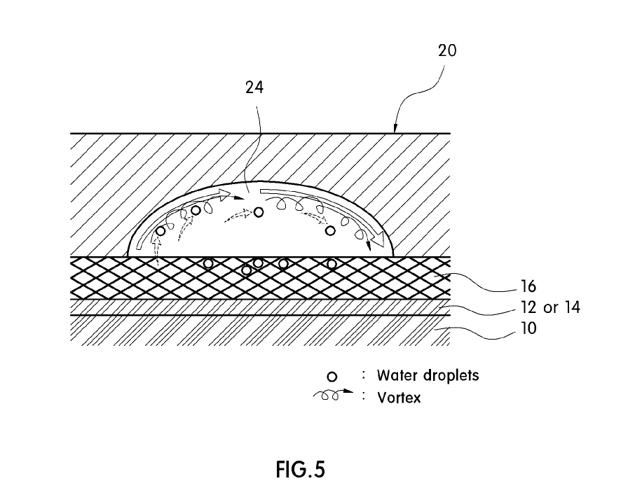

FIG. 6 is a diagram showing a laminar flow of reactant gases in a conventional separator.

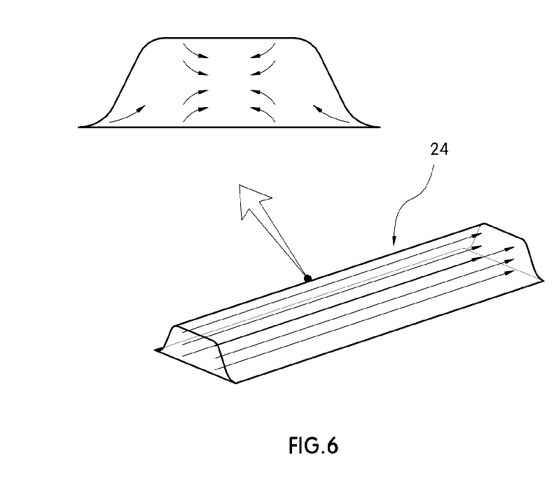

FIG. 7 is a diagram showing the structure of a typical separator.

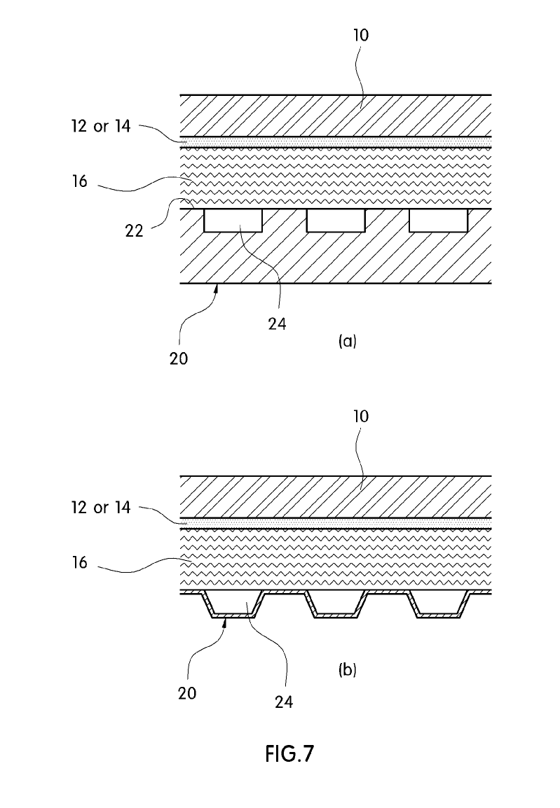

FIG. 8 is a diagram showing the configuration of a typical fuel cell stack.

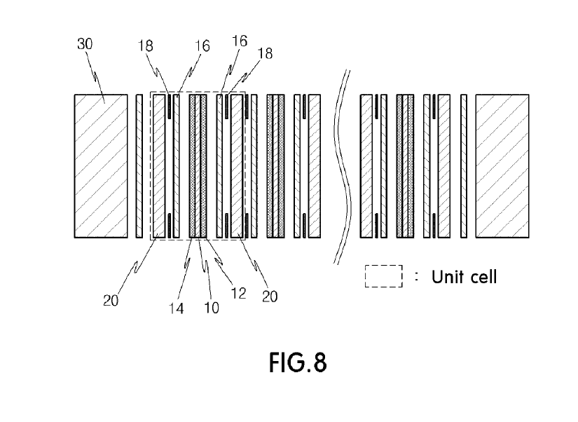

Reference numerals set forth in the Drawings includes reference to the following elements as further discussed below:

| | |
|---|---|
| 10: polymer electrolyte membrane | 12: air electrode |
| 14: fuel electrode | 16: gas diffusion layer |
| 18: gasket | 20: separator |
| 22: land | 24: channel |
| 30: end plate | 40: vortex generating structure |
| 42: spiral projection | 44: spiral groove |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The present invention provides a fuel cell separator including a channel having an improved structure to induce a vortex of reactant gases flowing through the channel, thus facilitating the removal of water droplets from a gas diffusion layer (GDL).

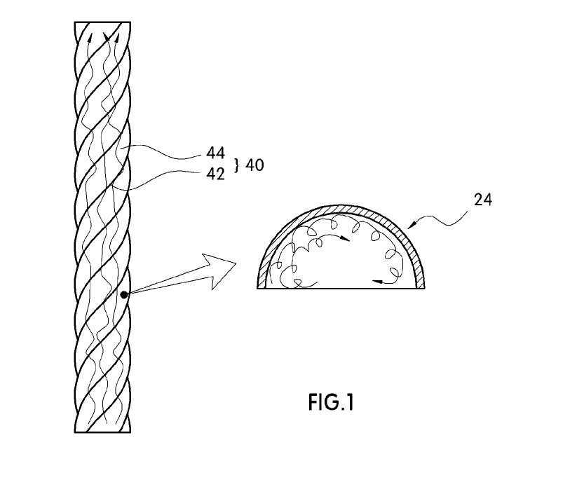

For this purpose, as shown in FIGS. 1 to 3, a vortex generating structure 40 for inducing a vortex of reactant gases is integrally formed on the entire or partial surface of a channel 24 of a separator 20. That is, the separator 20 has a structure in which a land joined to the GDL and a channel formed between the lands and serving as a passage of reactant gases are repeatedly formed. The vortex generating structure 40 capable of inducing a vortex of reactant gases is integrally formed on the surface of each channel 24.

A vortex generating structure 40 of a separator 20 in accordance with an embodiment of the present invention, as shown in FIG. 1, has a structure in which the inside of a channel 24 has a semicircular cross-section and a plurality of spiral projections 42 and grooves 44 each having a semicircular curved surface are repeatedly formed in the inner surface of the channel 24 along the flow direction of the reactant gases.

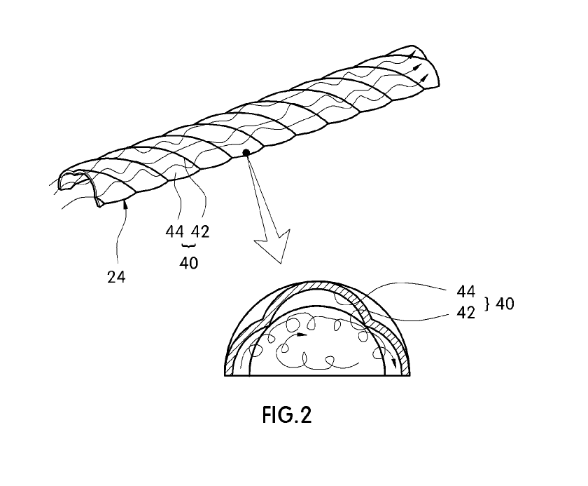

A vortex generating structure 40 of a separator 20 in accordance with another embodiment of the present invention, as shown in FIG. 2, has a structure in which the inside of a channel 24 has an elliptical cross-section and a plurality of spiral projections 42 and grooves 44 each having an elliptical curved surface are repeatedly formed in the inner surface of the channel 24 along the flow direction of the reactant gases.

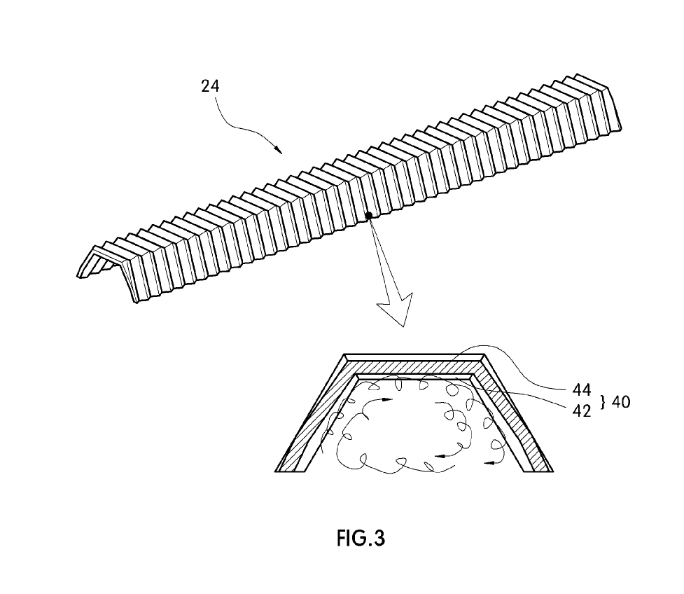

A vortex generating structure 40 of a separator 20 in accordance with still another embodiment of the present invention, as shown in FIG. 3, has a structure in which the inside of a channel 24 has a trapezoidal cross-section and a plurality of spiral projections 42 and grooves 44 each having a semicircular or elliptical curved surface are repeatedly formed in the inner surface of the channel 24 along the flow direction of the reactant gases.

By the vortex generating structures 40 in accordance with the embodiments of the present invention, the vortex of reactant gases flowing through the channel 24 is easily induced, and thus the reactant gases can flow in a substantially straight direction. Especially, the surface of the GDL 16 facing the channel 24 has hydrophobicity, and thus water droplets cannot be introduced into the GDL 16 even when the volume of water droplets is increased along the wall of the channel 24 including the vortex generating structure 40. Moreover, even small water droplets absorbed in open pores of the GDL 16 can be ejected toward the channel 24 and thus easily removed by the vortex of reactant gases.

Meanwhile, the amount of water droplets discharged from the GDL 16 may vary according to the size and type of the fuel cell stack, and thus each of the vortex generating structures 40 in accordance with the embodiments of the present invention may be formed on the entire or partial surface of the channel 24 of the separator 20.

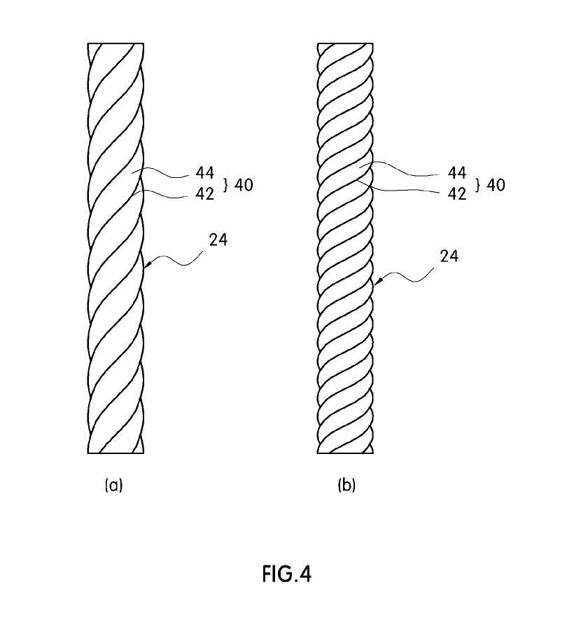

Moreover, as shown in FIG. 4, it is possible to control the strength of the vortex of reactant gases generated and, at the same time, improve the removal efficiency water droplets from the GDL 16 by the vortex of reactant gases by adjusting the number, radius, and length of the spiral projections 42 and grooves 44 of each of the vortex generating structures 40 in accordance with the embodiments of the present invention.

The vortex generating structure(s) 40 in accordance with the embodiments of the present invention may be integrally formed on the surface of the channel 24 by a mechanical process or stamping process. Otherwise, the vortex generating structure(s) 40 may be separately formed in advance and then attached to the surface of the channel 24 using an adhesive means.

Therefore, when the reactant gases (i.e., hydrogen and oxygen in the air) flow through each channel 24 of the separator 20 according to the present invention, the reactant gases flow along the spiral projections 42 and grooves 44 of the vortex generating structure 40 formed on the surface of the channel 24 and move down toward the GDL 16, thus generating a vortex.

Therefore, the reactant gases in the channel 24 can be more efficiently supplied to the electrodes, i.e., the fuel electrode and air electrode, through the GDL 16 by the generated vortex, compared to the conventional laminar flow.

Especially, water droplets having a small volume trapped in open pores of the GDL 16 are ejected toward the channel 24 by the downward movement of the reactant gases toward the GDL 16, and thus the water removal efficiency with respect to the GDL 16 can be improved. Moreover, the amount of reactant gases supplied to the electrodes can be increased by the removal of water droplets from the GDL 16, and thus the supply efficiency of the reactant gases can be improved.

As described above, according to the present invention, the vortex generating structure capable of inducing a vortex of reactant gases is integrally formed on the surface of each channel of the separator such that the reactant gases in each channel of the unit cell of the fuel cell stack can flow through the vortex, and thus water droplets trapped in the GDL facing the cannel are ejected to the surface of the GDL and moved along the flow direction of the reactant gases to be easily removed. As a result, it is possible to prevent the occurrence of flooding in the GDL and electrodes due to insufficient water removal, thereby making it possible to prevent the deterioration of performance of the fuel cell stack.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A fuel cell separator comprising:
lands being in contact with a gas diffusion layer;
a channel formed between two of the lands and serving as a passage of reactant gases; and
a vortex generating structure integrally formed on the surface of the channel for inducing a vortex of reactant gases.

2. The fuel cell separator of claim 1, wherein the vortex generating structure is formed on the entire or partial surface of the channel.

3. The fuel cell separator of claim 1, wherein the vortex generating structure is integrally formed by a stamping process on the surface of the channel.

4. The fuel cell separator of claim 1, wherein the vortex generating structure is separately formed in advance.

5. The fuel cell separator of claim 1, wherein the inside of the channel has a semicircular, elliptical, or trapezoidal cross-section.

6. The fuel cell separator of claim 5, wherein the vortex generating structure comprises a plurality of spiral projections and grooves each having a semicircular or elliptical curved surface and repeatedly formed along the flow direction of the reactant gases.

7. The fuel cell separator of claim 6, wherein the number, radius, and length of the spiral projections and grooves of the vortex generating structure are adjusted to control the strength of the vortex of reactant gases generated.
